(19) United States
(12) Patent Application Publication
(10) Pub. No.: US 2005/0157597 A1
(43) Pub. Date: Jul. 21, 2005

(54) Optimized media grain packing fraction for bit patterned magnetic recording media

(75) Inventors: Ibrahim Kursat Sendur, Pittsburgh, PA (US); Dieter Weller, San Jose, CA (US)

Correspondence Address: LIU & LIU, 444 S. FLOWER STREET SUITE 1750, LOS ANGELES, CA, 90071, US

(73) Assignee: Seagate Technology LLC

(21) Appl. No.: 11/050,919

(22) Filed: Feb. 4, 2005

Related U.S. Application Data
(63) Continuation-in-part of application No. 10/447,602, filed on May 29, 2003.

(51) Int. Cl. G11B 7/26

(52) U.S. Cl. 369/13.55; 369/288

(57) ABSTRACT

A bit patterned magnetic recording medium for use in HAMR, which is optimized for optical coupling efficiencies and improved magnetic read-back coupling. The medium comprises bit-patterned magnetic recording elements, each corresponding to a magnetic data bit, and each comprising a cluster of discrete and separated magnetic grains. The desired packing fraction may be obtained by defining the number of grains within a bit, while bit-patterning provides efficient optical transmission. The grains have an effective packing fraction that enhances magnetic read-back signals, and the bits are distributed in a pattern having a packing fraction that enhances the optical coupling efficiency. The bits and/or the grains may be substantially thermally and optically isolated.

### RELATED APPLICATION

This application is a continuation-in-part of co-pending U.S. patent application Ser. No. 10/447,602, filed May 29, 2003 (Seagate Docket No. 11131), which has been commonly assigned to the assignee of the present application, and is fully incorporated by reference as if fully set forth herein.

### STATEMENT REGARDING FEDERALLY SPONSORED RESEARCH OR DEVELOPMENT

This invention was made with United States Government support under Agreement No. 70NANB1H3056 awarded by the National Institute of Standards and Technology (NIST).

The United States Government has certain rights in the invention.

### FIELD OF THE INVENTION

The present invention relates to magnetic recording media, and in particular to patterned magnetic recording media; and more particularly to patterned magnetic recording media for heat assisted magnetic recording.

### BACKGROUND OF THE INVENTION

There are many different forms of data recording. For example, magnetic data recording is one of the prevailing forms of data recording. Magnetic data recording may be implemented using different types of magnetic recording media, including tapes, hard discs, floppy discs, etc. Over the years, significant developments have been made to increase the areal data recording density in magnetic data recording.

Superparamagnetism is a major limiting factor to increasing magnetic recording areal density. Superparamagnetism results from thermal excitations perturbing the magnetization of grains in a ferromagnetic material, making the magnetization unstable. As the magnetic media grain size is reduced for high areal density recording, superparamagnetic instabilities become more of an issue. The superparamagnetic effect is most evident when the grain volume V is sufficiently small that the inequality KᵤV/k_{B}T>40 can no longer be maintained. Kᵤ is the material's magnetic crystalline anisotropy energy density, k_{B} is the Boltzmann's constant, and T is absolute temperature. When this inequality is not satisfied, thermal energy demagnetizes the individual grains and the stored data bits will not be stable. Therefore, as the grain size is decreased in order to increase the areal density, a threshold is reached for a given material Kᵤ and temperature T such that stable data storage is no longer feasible.

The thermal stability can be improved by employing a recording medium formed of a material with a very high Kᵤ. However, the available recording heads are not able to provide a sufficiently high enough magnetic writing field to write on such a medium. Conventional magnetic recording techniques will likely reach physical limits to storage density which are due to the super-paramagnetic effect. Heat Assisted Magnetic Recording (HAMR), sometimes referred to as optical or thermal assisted recording, has been proposed to overcome at least some of the problems associated with the superparamagnetic effect. HAMR generally refers to the concept of locally heating a recording medium (e.g., with a laser) to reduce the coercivity of the recording medium, so that an applied magnetic writing field can more easily direct the magnetization of the recording medium during the temporary magnetic softening of the recording medium caused by the laser. By heating the medium, the Kᵤ or the coercivity is reduced such that the magnetic write field is sufficient to write to the medium. Once the medium cools to ambient temperature, the medium has a sufficiently high value of coercivity to assure thermal stability of the recorded information. HAMR allows for the use of small grain media, which is desirable for recording at increased areal densities, with a larger magnetic anisotropy at room temperature to assure sufficient thermal stability.

Extremely small thermal spots with high temperatures are required in a HAMR system to reduce the coercivity of the medium. To achieve such thermal spots, a focused optical beam from a laser with extremely high transmission efficiency is needed. Several near field optical transducers have been proposed to achieve high transmission efficiencies in small spots, however, numerical simulations suggest that the transmission efficiency of these near field optical transducers may not be large enough to achieve high temperatures in extremely small spots. Further efforts are being undertaken to develop more effective near field optical transducers having higher transmission efficiencies.

In parallel to the development of more effective near field optical transducers, efforts have been directed to developing improved magnetic recording media that provides more efficient optical coupling to currently achievable near field optical transducers. For example, in the parent U.S. patent application Ser. No. 10/447,602, a magnetic recording medium is disclosed which increases the optical coupling efficiencies between the near field optical transducers and the magnetic recording medium required in a HAMR system. The disclosed medium utilizes isolated bit patterned media volumes (i.e., discrete magnetic recording elements, each corresponding to a magnetic bit for data recording), to increase the light coupling and temperature response. More specifically, in the embodiments disclosed in the application, the recording elements are arranged in an array with uniform spacing over the plane of the medium substrate. Furthermore, the medium utilizes a heat-sink underlayer that reduces the coupling inefficiency due to fringing of the electric field lines and removes the heat quickly from the medium to reduce heat influence on neighboring media volumes. The underlayer can be characterized as an “optical soft underlayer” in analogy to the magnetic soft underlayer in perpendicular magnetic recording. The advantages and the optical and thermal aspects of the medium can be referenced from the parent application, which has been fully incorporated by reference herein.

It was discussed in the parent application that efficient coupling of electric field into the recording medium requires large separation of media grains, which results in a low media grain packing fraction of the grains. Recent studies suggest that a low packing fraction possibly results in added DC noise, which is undesirable for the data read phase of the magnetic recording as it may lead to read data errors. More importantly, a low packing fraction reduces the magnetic moment density in the medium, thereby limiting the read signal strength, which potentially introduces additional noise or errors in the read signal.

Accordingly, there is a need for a HAMR medium that has a high optical transmission efficiency without sacrificing read data integrity.

### SUMMARY OF THE INVENTION

The present invention is directed to a bit patterned magnetic recording medium for use in HAMR, which optimizes optical coupling efficiencies and media grain packing fraction for improved magnetic coupling. The medium comprises bit-patterned media volumes or magnetic recording elements, each corresponding to a magnetic data bit, and each comprising thermally and optically isolated magnetic grains or particles. The desired packing fraction may be obtained by defining the number of grains within a bit, while bit-patterning provides efficient optical transmission.

In one aspect of the present invention, the medium comprises an array of discrete and separated bits in the magnetic layer, which bits each comprises a cluster or array of discrete and separated media volumes or grains, having an effective packing fraction that enhances magnetic read-back signals. The bits are distributed in a pattern having a packing fraction that enhances the optical coupling efficiency. The bits and/or the grains may be substantially thermally and optically isolated.

In one embodiment, the bits are separated from each other in a pattern whereby the bits are uniformly distributed across the magnetic layer, but the overall distribution of the grains is non-uniform across the magnetic layer.

In another embodiment of the present invention, the medium comprises a heat sink underlayer.

In another aspect of the present invention, the medium comprises discrete and separated media grains in the magnetic layer, which are distributed in a pattern that takes into consideration of the pattern of the grains within a bit for purpose of grain packing fraction to improve magnetic read-back signal, in addition to the pattern of the bits to improve the optical coupling efficiencies.

In one embodiment, the patterning of the bits takes into consideration the physical coverage of actual area of the magnetic grains over the area of recording medium surface over which magnetic grains are extended, which provides an indication of the grain packing fraction (PF) as it affects the relative optical coupling efficiencies. In addition, the patterning of the grains in a bit takes into consideration the coverage of the actual magnetic material in one bit area on the recording medium surface, which provides an indication of the grain packing fraction (EPF) as it affects the relative magnetic read-back signal strengths.

In a further aspect of the present invention, the magnetic recording medium in accordance with the present invention is designed for use in a HAMR system. In one embodiment, the HAMR system is of the perpendicular recording type.

### BRIEF DESCRIPTION OF THE DRAWINGS

For a better understanding of the nature and advantages of the invention, as well as the preferred mode of use, reference should be made to the following detailed description read in conjunction with the accompanying drawings. In the following drawings, like reference numerals designate like or similar parts throughout the drawings.

FIG. 1 is a pictorial representation of a magnetic disc drive that incorporates a magnetic recording medium in accordance with one embodiment of the present invention.

FIG. 2 is a partial schematic side view illustrating perpendicular recording on a magnetic recording media in a HAMR system in accordance with one embodiment of the present invention.

FIG. 3a is a schematic representation of a near field optical transducer in the form of a pin adjacent to a conventional recording medium; FIG. 3b is a schematic representation of a near field optical transducer in the form of a pin adjacent to a recording medium according to one embodiment of the present invention.

FIGS. 4(a)-(d) illustrate the bit and grain distribution in the magnetic layer in accordance with one embodiment of the present invention. FIG. 4(a) is a perspective view of the magnetic layer; FIG. 4(b) is a top view of the magnetic layer; FIG. 4(c) is a sectional view taken along line 4c-4c in FIG. 4(b); and FIG. 4(d) is a sectional view taken along line 4d-4d in FIG. 4(b).

FIGS. 5(a)-(d) illustrate the bit and grain distribution in the magnetic layer in accordance with another embodiment of the present invention. FIG. 5(a) is a perspective view of the magnetic layer; FIG. 5(b) is a top view of the magnetic layer; FIG. 5(c) is a sectional view taken along line 5c-5c in FIG. 5(b); and FIG. 5(d) is a sectional view taken along line 5d-5d in FIG. 5(b).

FIGS. 6(a)-(d) illustrate the bit and grain distribution in the magnetic layer in accordance with a further embodiment of the present invention. FIG. 6(a) is a perspective view of the magnetic layer; FIG. 6(b) is a top view of the magnetic layer; FIG. 6(c) is a sectional view taken along line 4c-4c in FIG. 6(b); and FIG. 6(d) is a sectional view taken along line 6d-6d in FIG. 6(b).

FIG. 7 is a schematic plan view of the magnetic layer, illustrating a symmetrical array of bit and grain, with a particular packing fraction (PF) and effective packing fraction (EPF).

FIGS. 8(a) and FIG. 8(b) illustrates further embodiment of bit and grain distributions in accordance with the present invention, which have relatively less desirable PF and EPF.

### DETAILED DESCRIPTION

The present description is of the best presently contemplated mode of carrying out the invention. This description is made for the purpose of illustrating the general principles of the invention and should not be taken in a limiting sense. The scope of the invention is best determined by reference to the appended claims. This invention has been described herein in reference to various embodiments and drawings. It will be appreciated by those skilled in the art that variations and improvements may be accomplished in view of these teachings without deviating from the scope and spirit of the invention.

The present invention is directed to a bit patterned magnetic recording medium that optimizes optical coupling efficiencies and media grain packing fraction. As will be described below, in one aspect, the medium comprises discrete and separated bits in the magnetic layer, which bits each comprises a cluster of discrete and separated media volumes or grains, having a packing fraction that enhances magnetic read-back signals. The bits are distributed in a pattern that enhances the optical coupling efficiency. The bits and/or the grains may be substantially thermally and optically isolated. In another aspect, the medium comprises discrete media grains in the magnetic layer, which are distributed in a pattern that takes into consideration of the pattern of the grains within a bit for purpose of grain packing fraction to improve magnetic read-back signal, in addition to the pattern of the bits to improve the optical coupling efficiencies.

By way of illustration and not limitation, the present invention will be described in connection with a HAMR disc drive system, and in particular a perpendicular magnetic recording disc drive system that employs HAMR. Perpendicular magnetic recording, as used herein, generally refers to orienting magnetic domains within a magnetic recording medium substantially perpendicular to the direction of travel of the recording head and/or recording medium. By way of illustration and not limitation, the present invention will be described in connection with a magnetic data recording head (generally refers to a head capable of performing read and/or write operations) and system, and in particular a HAMR head and system in which both data writing and reading are effected by magnetic induction.

Although various embodiments of the inventive medium is described herein below in reference to perpendicular HAMR recording, in accordance with one embodiment of the present invention, it will be appreciated that the various aspects of the invention may also be used in conjunction with other types of recording where it may be desirable to deploy the inventive magnetic recording medium and/or HAMR. For example, it will be appreciated that the inventive medium may also be adapted for use in conjunction with longitudinal media recording, tilted media recording, etc., where it may be desirable to employ HAMR on a bit-patterned medium. It is also well contemplated that the novel magnetic recording medium of the present invention may be applied to other types of magnetic data recording system, such as tape drives, floppy disc drives, etc., which may comprise in addition to magnetic data recording, other forms of data reading, such as a magneto-optical recording system, phase change media using optical or other methods of data read-back, or other hybrid recording systems, without departing from the scope and spirit of the present invention.

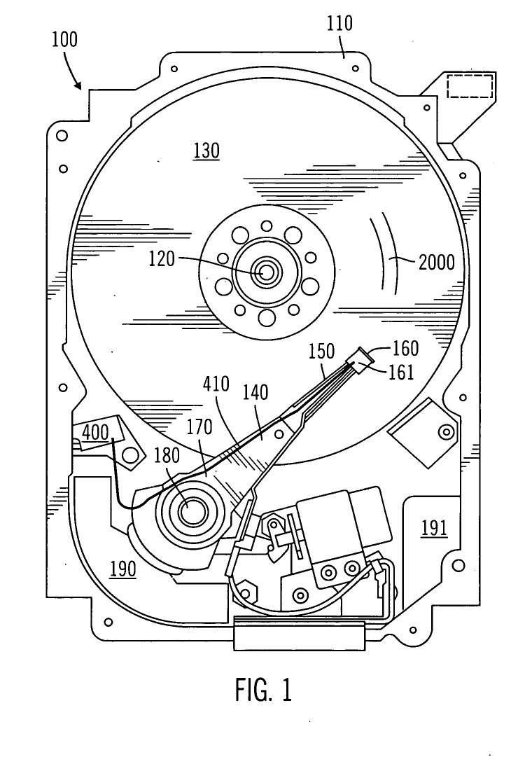

FIG. 1 is a pictorial representation of a magnetic disc drive 100 that incorporates the inventive recording medium, in accordance with one embodiment of the present invention. The disc drive 100 includes a housing 110 (with the upper portion removed and the lower portion visible in this view) sized and configured to contain the various components of the disc drive 100. The disc drive 100 includes a spindle motor 120 for rotating at least one magnetic storage medium 130 within the housing 110. At least one arm 140 is contained within the housing 110, with the arm 140 having a first end 150 with a recording head 160 supported on a slider 161 (the combination of the slider 161 and head 160 is generally referred to as a magnetic transducer), and a second end 170 pivotally mounted on a shaft by a bearing 180. The slider 161 has an air-bearing surface (typically patterned with certain surface features) facing the medium 130. The aerodynamic interactions between the slider air-bearing surface and the medium 130 creates an air gap or an air bearing against the medium 130. An actuator motor 190 (e.g., a voice-coil motor) is located at the arm's second end 170 for pivoting the arm 140 to position the recording head 160 over a desired sector or track 2000 of the disc 130. The actuator motor 190 is regulated by a controller 191.

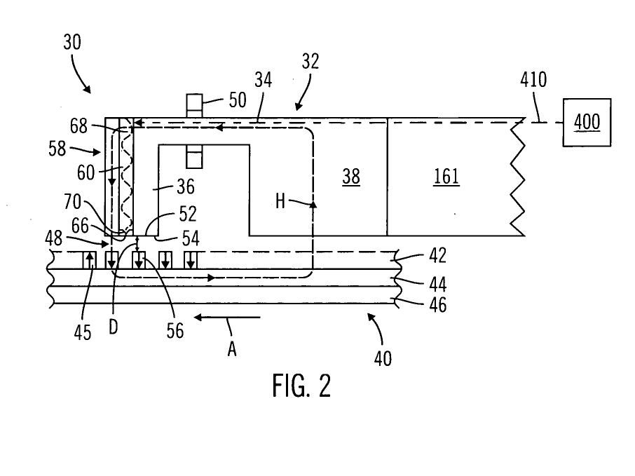

The disc drive 100 includes a source of radiant energy 400 and an optical fiber 410. The source 400 provides the radiation for the generation of surface plasmons or guided modes that travel toward an electromagnetic wave emission surface that is formed along the air-bearing surface of the recording head 160. (Further discussions of the structures relating to electromagnetic wave emission are given below in reference to FIG. 2.) The source 400 may be, for example, a laser diode, or other suitable lasers or coherent light source with sufficient radiant energy. The radiant energy can be in the form of, for example, visible light, infrared light, or other visible or invisible light in other frequency or wavelength spectrums. The optical fiber 410 facilitates transmission of the radiant energy from the source 400 to the recording head 160.

The controller 191, possibly in conjunction with control signals from an external information processing system, not shown, controls the operations and synchronizations of the various components of the disc drive 100, including the radiant energy source 400, in connection with data read and write operations.

Referring to FIG. 2, which is a partially schematic side view of one embodiment of a perpendicular magnetic recording head 30 (which may be substituted as the recording head 160 in FIG. 1), it is instructive to discuss the general operation of a perpendicular recording HAMR system. FIG. 2 also shows the magnetic recording medium 40 (which may be substituted as the recording medium 130 in FIG. 1) that is suitable for perpendicular magnetic recording. Perpendicular magnetic recording, as used herein, generally refers to orienting magnetic domains within a magnetic storage medium substantially perpendicular to the direction of travel of the recording head 30 and/or recording medium 40.

The recording head 30 may comprise a thin film structure, constructed using known processes including deposition, lithographic and etching steps. The recording head 30 includes a magnetic write head 32, which includes a yoke 34 that forms a write pole 36 and a return pole 38. The recording head 30 is positioned adjacent to a perpendicular magnetic storage medium 40. An air bearing 48 separates the recording head 30 from the storage medium by a distance D. A coil 50 is used to control the magnetization of the yoke to produce a write field at an end 52 of the write pole 36 adjacent to an air-bearing surface 54 of the recording head 30. It will be appreciated that the recording head 30 may be constructed with a write pole 36 only and no return pole 38. The recording head 30 can also include a magnetic read head, not shown in FIG. 2, which may be any conventional type magnetic read head as is generally known in the art (i.e., the type that senses changes in electrical signal induced by magnetic data). In another embodiment of the HAMR system not illustrated by the drawings, the read head is an optical read head that senses the influence of magnetization on an optical signal, as is found in a magneto-optical recording system. The perpendicular magnetic storage medium 40 is positioned adjacent to or under the recording head 30 and travels in the direction of arrow A.

The recording medium 40 includes a substrate 46, which may be made of any suitable material such as ceramic glass or amorphous glass. An electrically conductive and thermally conductive heat sink layer 44 is deposited on the substrate 46. The heat sink layer 44 may be made of any suitable material such as, for example, alloys or multilayers including gold, copper, silver or aluminum. According to the present invention, a bit-patterned magnetic recording layer 42 having a plurality of isolated magnetic recording elements 45 is formed on the heat sink layer 44, with the perpendicular oriented magnetic domains 56 contained in the magnetic recording elements 45. As will be described in greater detail below, the recording elements 45 each included a plurality of thermally and optically/field isolated grains, such as in the format of a self-assembled monolayer having a distribution and packing fraction as discussed below. Suitable magnetic materials for the magnetic recording layer 42 may include at least one material selected from, for example, FePt, CO₃Pt or CoCrPt alloys or Co/Pt or Co/Pd multilayers having a relatively high perpendicular magnetic anisotropy at ambient temperature. The patterning of self-assembled monolayers may be by means of any known process, which may include lithography and deposition techniques. Reference may be made to Patterning of Self-Assembled Monolayers with Lateral Dimensions of 0.15 μm Using Advanced Lithography; Yang et al., Journal of Vacuum Science Technology Bulletin 17 (6), pp. 3203-3207, November/December 1999; which is fully incorporated by reference herein.

A soft magnetic underlayer (not shown) may be formed between the substrate 46 and the heat sink layer 44, or between the heat sink layer 44 and the magnetic layer 42. The soft magnetic underlayer may be made of any suitable material such as, for example, alloys or multilayers having Co, Fe, Ni, Pd, Pt or Ru.

The recording head 30 also includes means for inducing heat in the magnetic storage medium 40 proximate to where the write pole 36 applies the magnetic write field H to the storage medium 40. Specifically, the means for inducing heating includes an optical waveguide 58 which may be formed by a transparent layer 60. The optical waveguide 58 receives radiant energy delivered by the optical fiber (schematically represented by dotted line 410) from the source 400 (see also FIG. 1). The radiant energy can be, for example, visible light, infrared or ultra violet radiation, coupled to the waveguide 58. The source 400 provides the optical radiation for the transformation to electromagnetic radiation to be directed at the magnetic medium 40. The optical radiation produces guided modes through the waveguide 58, to a near-field electromagnetic radiation transducer 70 (schematically shown in FIG. 2). The interaction of condensed optical radiation and the near-field electromagnetic transducer 70 generates surface plasmons that are directed towards an electromagnetic radiation emission surface 66 that is formed along the air-bearing surface 54 of the recording head 30. The transmitted electromagnetic radiant energy, generally designated by reference number 68, passes from the radiation emission surface 66 of the transducer 70 to the surface of the storage medium, to induce heat within a localized area of the storage medium 40, and particularly for inducing heat in a localized area of the hard magnetic layer 42. The near-field radiation transducer 70 (sometimes referred as a near-field optical transducer) may be in the form of a pin provided adjacent to an end of the optical waveguide 58 (as shown in the embodiments described below). The media of the present invention can be used in combination with other types of radiation transducers, such as one that uses a ridge waveguide.

At the surface of the medium 40, a portion of the transmitted electromagnetic radiant energy converts into heat. The transparent layer 60 may be formed, for example, from a silica based material, such as SiO₂. The transparent layer 60 should be a non-conductive dielectric, and have extremely low optical absorption (high transmissivity). It will be appreciated that in addition to the transparent layer 60, the waveguide 58 may include an optional cladding layer, such as aluminum, positioned adjacent the transparent layer 60 or an optional overcoat layer, such as an alumina oxide, for protecting the waveguide 58.

At a downtrack location, when the medium 40 is moved to position the heated spot under the write pole 36, the write pole 36 applies a magnetic write field H to the heated spot, corresponding to write data. The heat sink layer 44, and/or the soft magnetic underlayer if provided, provides a return path for the field H, as shown in FIG. 2. The write field H is applied while the spot remains at a sufficiently high temperature for lowering the coercivity of the recording medium 130. The write pole 36 has a relatively high saturation magnetic moment, thereby resulting in a strong magnetic write field H. The strong magnetic write field H permits use of the recording medium 40 having a relatively high coercivity or anisotropy, thereby limiting superparamagnetic instabilities even at high recording densities.

In one aspect of the present invention, the medium 40 comprises an array of discrete and separated bits in the magnetic layer 42, which bits each comprises a cluster or array of discrete and separated media volumes or grains, having a packing fraction that enhances magnetic read-back signals. The bits are distributed in a pattern that enhances the optical coupling efficiency. The bits and/or the grains may be substantially thermally and optically isolated. In one embodiment, the bits are separated from each other in a pattern whereby the bits are uniformly distributed across the magnetic layer 42, but the overall distribution of the grains is not uniform across the magnetic layer 42.

Prior to a detail discussion of specific embodiments of the distribution of the grains and bits, it is instructive to first discuss the effects of discrete grains on optical coupling. Reference is also made to the parent patent application Ser. No. 10/447,602 that had been incorporated by reference hereinabove.

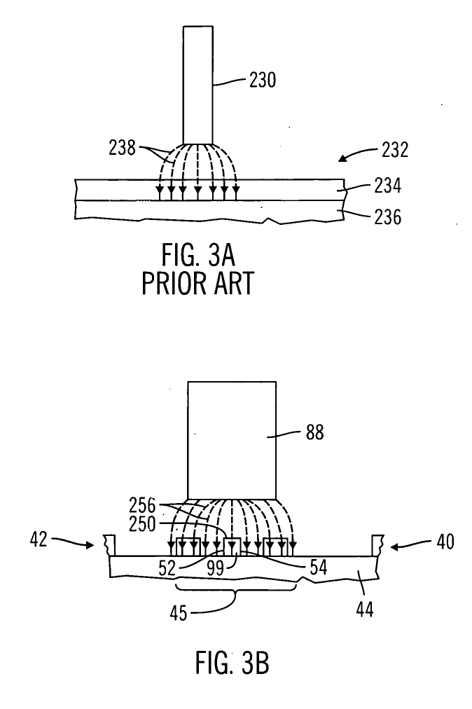

In the examples discussed herein below, a metal pin (e.g., pin 88 in FIG. 3b) is used as an example of a transducer to concentrate optical energy into arbitrarily small areal dimensions. The metal pin can support a surface plasmon mode, which propagates along the pin, and the width of the external electric field generated by the surface plasmon mode is proportional to the diameter of the pin. Smaller pin diameters result in smaller effective spot sizes, and in principle the spot size can be made arbitrarily small. Although a metallic pin can be used as a near field transducer, the media of this invention will improve the thermal transmission efficiency of other near field transducers as well. As an example, a “ridge waveguide” transducer could be used.

FIG. 3a is a schematic representation of a pin 230 adjacent to a conventional recording medium 232, including a magnetic layer 234 and a heat sink layer 236 (the substrate layer is omitted from the partial drawing of the medium 232). The pin 230 can be made of a metal such as gold. Electric field lines 238 are shown to be substantially normal to the surface of the magnetic layer 234.

FIG. 3b is a schematic representation of a pin 88 adjacent to a bit patterned recording medium 40 in accordance with one embodiment of the present invention, including a magnetic recording layer 42 having a plurality of isolated magnetic recording grains 99 and a heat sink layer 44 (the substrate layer is omitted from the partial drawing of the medium 40). In this particular example, the effective spot size of the pin 88 covers a 3×3 array of nine grains 99 in a rectangular and more specially a square bit cluster 45 (FIG. 3b is a sectional view showing only three grains 99 in a linear array). Each of the magnetic recording grains includes a top surface 250 and side surfaces 252 and 254. Electric field lines 256 are shown to be substantially normal to the surface of the heat sink 248. The isolated magnetic recording grains are separated by an electrically insulating material, which in this example is air. However, it should be understood that other electrically and thermally insulating materials can be positioned between the recording elements, and/or an electrically insulating lubricant can be applied to the surface of the media, with the lubricant filling the spaces between the isolated magnetic recording elements. Alternatively, a planarization material that is magnetically transparent may be utilized to planarize the layer 42 of magnetic grains 99.

In the case of conventional media, the electric field lines 238 are normal to the magnetic layer 234 of the medium 232 as shown in FIG. 3a. However, in the case of the patterned medium 40, the electric field lines 266 are both normal (at the top surfaces) and tangential (on the side surfaces) to the isolated magnetic recording grains 99 of the inventive medium 40 as shown in FIG. 3b. The normal component of the electric field intensity across an interface is discontinuous. The tangential components of the electric field across an interface between two media (with no impressed magnetic current densities along the boundary of the interface) are continuous. With the recording medium of FIG. 3b, the electric field 256 is continuous along the sides of the magnetic recording grains 99. That is, the sides of the magnetic recording grains 99 form a boundary of the grain to air interface. Due to this continuity, the tangential components of the field will couple better to the grains. Therefore, much higher absorbed optical power is expected in the ease of patterned media.

For the patterned medium 40, the fields 256 couple to the medium through the interactions along the side surfaces 252 and 254 as well as the top surface 250. Thus the effective thermal coupling surface per unit volume is increased in the patterned media case. If the magnetic recording grains 99 are in the shape of cubes, the effective coupling surface increase is five times. If the magnetic recording grains 99 are 5 nm×5 nm×10 nm (height) rectangular prisms, the effective coupling surface increase is nine times. The field couples better on the side surfaces than at the top surface.

The spread of the absorbed power is reduced since the medium 40 is digitized and the air between the isolated magnetic recording grains 99 is a relatively good electrical insulator. Therefore, smaller full width half maximum (FWHM) spot sizes can be expected for patterned media. The heat sink 44 is a better electrical conductor than the recording layer 42. Therefore, it forces the electric field lines to be normal to the surface of the heat sink, which prevents the fringing of the electric field lines in the patterned medium case. The absorbed optical/thermal power per effective volume is increased because of the increase in the electric field intensities, better coupling, and reduced effective volume. Therefore, the source function in heat transfer (the heat generation source per unit volume) is increased, which will result in higher temperatures in the grains 99.

The increased source function is not the only factor contributing to the heating improvements. The heat loss to neighboring grains via thermal conduction is reduced by using discrete magnetic recording grains. In the various examples discussed herein below, air fills the gaps between the magnetic recording grains or particles, and air is a relatively good insulator. However, it should be recognized that other insulating materials can and may be used in the spaces between the magnetic recording elements, to prevent the heat loss to neighboring grains via thermal conduction. Thus the use of discrete magnetic recording grains should further enhance the temperature increases. For the patterned medium, a less aggressive heat sink layer can be used than would be needed in a conventional medium having a continuous magnetic layer, since the thermal spread is prevented and smaller thermal FWHMs are expected. A less aggressive heat sink layer means higher temperature increases.

Several combinations of bit/grain pattern configurations are possible to achieve the benefits of the present invention, as illustrated in the various embodiments discussed herein below. It is well understood that variations of these configurations may be obtained without departing from the scope and spirit of the present invention.

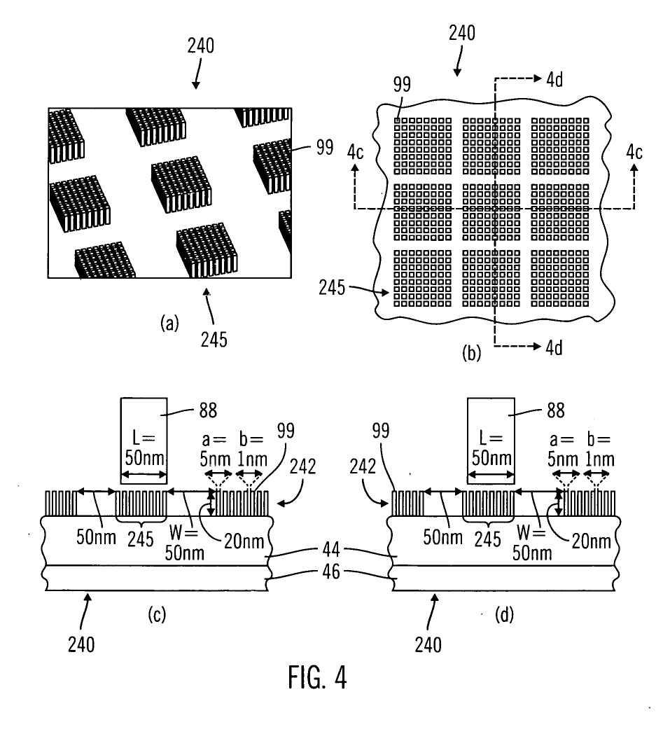

FIGS. 4(a)-(d) illustrate the bit and grain distribution in the magnetic layer 242 of a medium 240 in accordance with one embodiment of the present invention. FIG. 4(a) is a perspective view of the magnetic layer; FIG. 4(b) is a top view of the magnetic layer; FIG. 4(c) is a sectional view taken along line 4c-4c in FIG. 4(b); and FIG. 4(d) is a sectional view taken along line 4d-4d in FIG. 4(b). In this embodiment, the magnetic layer 242 comprises an array of square bits 245, each having an 8×8 array of discrete and separated grains. The bit-to-bit spacing W=50 nm (i.e., centerline spacing between bits is 100 nm). The grains are each 20 nm in height and 5 nm square (a=5 nm) in cross-section (top view), and the grain-to-grain spacing b=1 nm. The pin 88 is schematically shown to have an effective spot size (which may be different from the physical size of the pin) covering a 50 nm square (L=50 nm), that is the entire 8×8 array of grains 99, defining a bit 245.

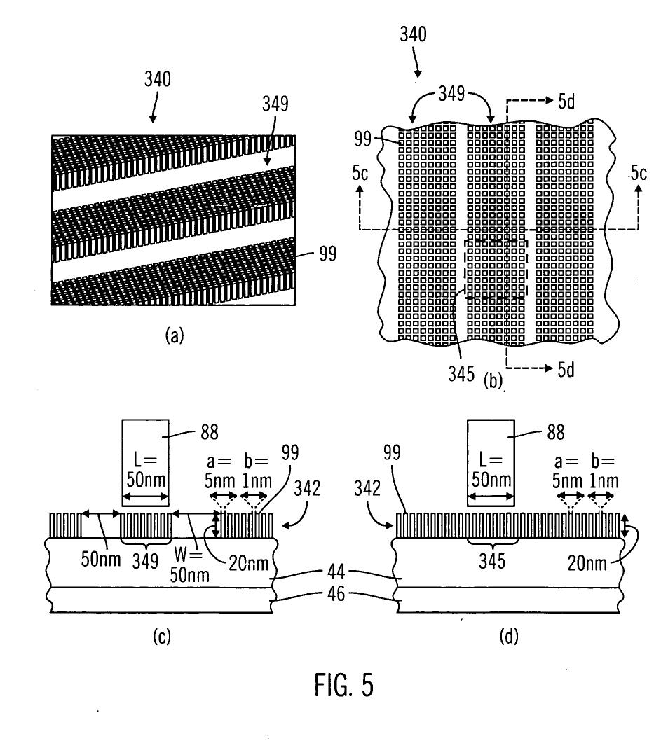

FIGS. 5(a)-(d) illustrate the bit and grain distribution in the magnetic layer 342 of a medium 340 in accordance with another embodiment of the present invention. FIG. 5(a) is a perspective view of the magnetic layer; FIG. 5(b) is a top view of the magnetic layer; FIG. 5(c) is a sectional view taken along line 5c-5c in FIG. 5(b); and FIG. 5(d) is a sectional view taken along line 5d-5d in FIG. 5(b). In this embodiment, the magnetic layer 342 comprises an array of parallel tracks 349, each comprising discrete and separated grains along the track. (It is noted that while the tracks are shown to be parallel, straight tracks, the tracks may be concentrically distributed on a circular disc. The tracks may therefore be slightly curved. The curvature is negligible given the width of the tracks with respect to the size of the disc, and may be ignored for purpose of analyzing herein a localized area on the tracks.) The tracks 349 are each eight grains wide. The track-to-track spacing W=50 nm (i.e., the centerline spacing between tracks is 100 nm). The grains are each 20 nm in height and 5 nm square (a=5 nm) in cross-section (top view), and the grain-to-grain spacing b=1 nm. The pin 88 is schematically shown to have an effective spot size covering a 50 nm square (L=50 nm), defining a bit 345, corresponding to an 8×8 array of grains 99.

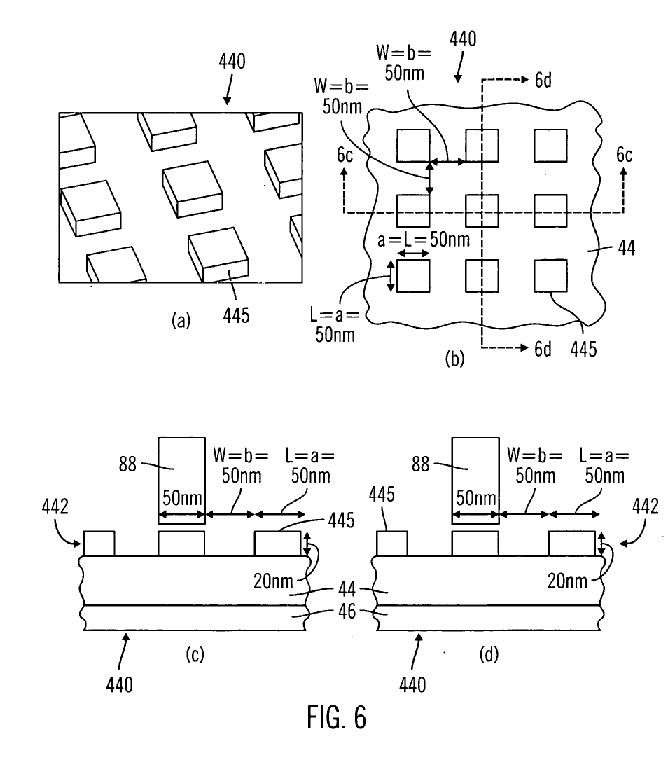

FIGS. 6(a)-(d) illustrate the bit and grain distribution in the magnetic layer 442 of a medium 440 in accordance with a further embodiment of the present invention. FIG. 6(a) is a perspective view of the magnetic layer; FIG. 6(b) is a top view of the magnetic layer; FIG. 6(c) is a sectional view taken along line 4c-4c in FIG. 6(b); and FIG. 6(d) is a sectional view taken along line 6d-6d in FIG. 6(b). In this embodiment, the magnetic layer 442 comprises an array of square grains defining bits 445. The bits are solid, each comprising one grain or particle that is 20 nm in height and 50 nm square (L=50 nm) in cross-section (top view). The bit-to-bit spacing W is 50 nm (i.e., centerline spacing is 100 nm). The pin 88 is schematically shown to have an effective spot size covering a 50 nm square (L=50 nm), defining the size of a bit 445. Since there is only one grain per bit, grain-to-grain spacing b=W=50 nm, and grain size a=L=50 nm.

The foregoing examples illustrate several combinations of different bit and grain distributions, having the same bit size corresponding to or defined by the effective spot size of the thermal transducer pin 88. As will be demonstrated later below, the embodiment of FIG. 4 has the best overall optical/thermal coupling and magnetic read-back characteristics, as compared to the embodiments of FIGS. 5 and 6. However, the latter embodiments may be more feasible from a practical manufacturing standpoint.

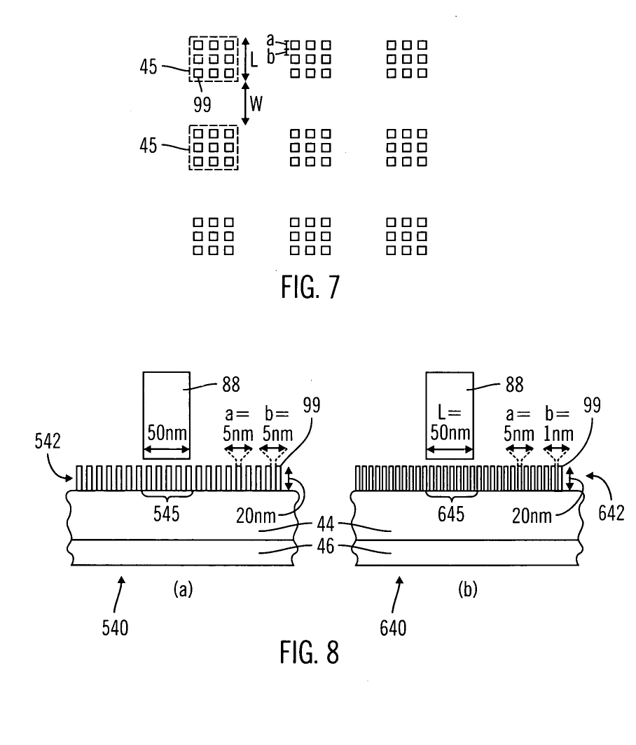

According to another aspect of the present invention, the particular distribution of the bits and grains may be determined based on considerations of two parameters. The present invention introduces two parameters, the “packing fraction” (PF) and the “effective packing fraction” (EPF). The EPF is an indicator representing the effectiveness of magnetic read-back signal provided by the medium. The PF is an indication representing the effectiveness of optical/thermal absorption by the medium. EPF of a medium is defined to be the ratio of the total area of magnetic material in one bit to the total area of the bit. PF of a medium is defined to be the ratio of the total area of physical coverage of magnetic grains to the total area of effective recording surface (i.e., the surface area available for recording by a recording head). EPF and PF are related, in that PF may be expressed as the product of EPF and the ratio of the total area of physical coverage of bits to the total area of effective recording surface. Both parameters are non-dimensional fractions varying from 0 to 1. Generally, the smaller the PF, the more effective is the optical/thermal absorption by the medium; the larger the EPF, the more effective is the magnetic read-back signal provided by the medium. Referring to FIG. 7, the PF and EPF parameters can be explained.

FIG. 7 illustrates an example comprising an array of square bits with sides of length L, and bit-to-bit spacing W. Each bit has a 3×3 array of square grains 99. Each grain 99 has sides of length a, and grain-to-grain spacing is b. For a two-dimensional symmetrical planar array having square bits of sides L and square grains of sides a, and a uniform bit-to-bit spacing W and grain-to-grain spacing b, the EPF and PF may be expressed as below.

$$\begin{matrix}\begin{matrix}EPF = ( Total area of the magnetic material in a bit ) \text{/} \\ ( Total area of a bit ) \\ = {a}^{2} \text{/} {( a + b )}^{2}\end{matrix} & ( 1 ) \\ \begin{matrix}PF = ( Total area of magnetic material ) \text{/} ( Total area \\ of recording surface ) \\ = \{ ( Total area of a bit ) \text{/} ( Total area of recording \\ surface ) \} \times \{ ( Total area of the magnetic material in \\ a bit ) \text{/} ( Total area of a bit ) \} \\ = \{ ( Total area of a bit ) \text{/} ( Total area of recording \\ surface ) \} \times EPF \\ = {L}^{2} \text{/} {( L + W )}^{2} \times EPF \\ = {L}^{2} \text{/} {( L + W )}^{2} \times {a}^{2} \text{/} {( a + b )}^{2}\end{matrix} & ( 2 )\end{matrix}$$

It is noted that the foregoing equations (1) and (2) are applicable to an array of uniformly and symmetrically distributed square bits and grains. For bits and grains of different geometries, appropriate modifications to the equations (1) and (2) should be made, to account for the geometrical area of the bits and grains, and any asymmetry of the array (e.g., spacing, etc.), to satisfy the definitions of the PF and EPF parameters.

Referring back to the embodiments in FIGS. 4 to 6, the respective EPF and PF parameters are calculated. (It is noted that the numerical results for the examples given below are approximate; to illustrate the relative values between the embodiments.)

For the embodiment of FIG. 4:
a=5 nm; b=1 nm; L=50 nm; W=50 nm
EPF=0.7; PF=0.175

For the embodiment of FIG. 6:
a=50 nm; b=0 nm; L=50 nm; W=50 nm
EPF=1.0; PF=0.25

For the embodiment of FIG. 5:
a=5 nm; b=1 nm; L=50 nm; “W”=50 nm (note: track-to-track spacing instead of bit-to-bit spacing)

The PF and EPF as defined still apply to the track type magnetic grain/bit distribution in FIG. 5. However the equation (2) expressed above should be modified to take into account the one-dimensional track-to-track spacing and the continuous linear array of grains orthogonal to the tracks. Modified equation (2)′ would be:
PF=L/(L+W)×a²/(a+b)² (2)′
Accordingly, EPF=0.7; PF=0.35

In comparison, for the conventional uniform continuous medium shown in FIG. 3(a), based on a transducer pin effective spot size of 50 nm square:
a=50 nm; b=0 nm; L=50 nm; W=0
EPF=1.0; PF=1.0

FIGS. 8(a) and 8(b) illustrate further examples of two-dimensional bit/grain arrays. FIG. 8(a) illustrates the bit and grain distribution in the magnetic layer 542 of a medium 540 in accordance with another embodiment of the present invention. In this embodiment, the magnetic layer 542 comprises a two-dimensional array of discrete grains 99 that are evenly spaced. The grain-to-grain spacing b is 5 nm. The grains are each 20 nm in height and 5 nm square (a=5 nm) in cross-section (top view). The pin 88 is schematically shown to have an effective spot size covering a 50 nm square (corresponding to an 5×5 array of grains 99), defining a bit 545 (L=50 nm; W=0 nm).

For FIG. 8(a):
a=5 nm; b=5 nm; L=50 nm; W=0 nm
EPF=0.25; PF=0.25

FIG. 8(b) illustrates the bit and grain distribution in the magnetic layer 642 of a medium 640 in accordance with another embodiment of the present invention. In this embodiment, the magnetic layer 642 comprises a two-dimensional array of discrete grains 99 that are evenly spaced. The grain-to-grain spacing b is 1 mm. The grains are each 20 nm in height and 5 nm square (a=5 nm) in cross-section (top view). The pin 88 is schematically shown to have an effective spot size covering a 50 nm square (corresponding to an 8×8 array of grains 99), defining a bit 645 (L=50 nm; W=0 nm).

For FIG. 8(b):
a=5 nm; b=1 nm; L=50 nm; W=0 nm
EPF=0.7; PF=0.7

Theoretical studies have been conducted utilizing finite element method (FEM) based 3-D electromagnetic modeling software to simulate the optical absorption profiles of various granular media having different bit/grain distributions. Based on the modeling data, it has been suggested that PF<0.5 and EPF>0.7 would present acceptable balance of optical absorption and magnetic read-back signal characteristics. It has been suggested that PFs below 0.6 could cause a high DC noise, which is undesirable for readout phase of the magnetic recording. Accordingly, in all the examples shown above, the embodiment of FIG. 4 appears to be the relative best pattern for optimized optical/thermal coupling and magnetic read-back signal. Even though the embodiment of FIG. 6 achieves a EPF=1.0 and PF=0.25, the optical coupling would be significantly worse than the embodiment of FIG. 4, in that in FIG. 6, the bit having a single large grain (50 nm square) does not provide sufficient vertical surfaces for increased optical coupling based on tangential field component, as compared to the use of many smaller discrete grains (each 5 nm square) in FIG. 4. (See also additional considerations discussed below in connection with obtaining a balance in characteristics of the magnetic medium).

While the examples above show the grains to be 20 nm in height, to avoid incoherent switching, smaller grain aspect ratio may be chosen. For example, the grain height may be reduced to 10 nm to reduce the bit aspect ratio. This may also allow for improved tribology with respect to the air bearing of the recording head/slider.

The foregoing discussions present a quantitative analysis on the parameters affected by planar bit and grain distributions, and the effect on optical/thermal coupling and magnetic read-back signal. Qualitative discussions are presented below to complement the quantitative analysis, with respect to various parameters and constraints, and their effects on optical/thermal coupling, magnetic read-back signals, and other design considerations for the magnetic recording medium.

The magnetic stability of a magnetized particle is directly proportional to V, the volume of the magnetic particle, the magnetic stability of the media can be increased by increasing the height of the particles to increase the particle volume for a given cross-section of the particles. The selection of this height is limited by tribological constraints. Alternatively, the width a of the grains can be increased, or the grain-to-grain separation distance b can be decreased, to increase the EPF. Although increasing the EPF can also increase the magnetic stability of the media, it significantly reduces the thermal transmission efficiencies, as it will significantly increase the PF.

To achieve higher transmission efficiencies to the media patterns near an optical transducer, the PF of the media and the width L of the bits and/or width a of the grains should be reduced and the grain height should be increased. This will make the media volumes more isolated and the electric field will better couple to the media due to the increase in the tangential component. Also, the volumes become more thermally isolated, which will increase the temperatures. However, as previously mentioned, inappropriate selection of these parameters may result in a magnetically unstable medium. Therefore, adjustment of the parameters PF, EPF and grain height can be necessary to optimize or obtain the desired magnetic stability and thermal coupling. The final adjustment may be subject to tribological constraints.

To achieve higher temperatures in the magnetic medium requires higher transmission efficiencies. Selecting the heat-sink layer as a good electric conductor permits higher transmission efficiencies. However, a good conductor will remove heat very quickly from the magnetic layer resulting in lower temperatures. Therefore, this trade-off between the electrical conductivity and thermal conductivity should be adjusted based on the temperature requirements. The thickness of the heat sink layer is another factor that affects the temperature increase of the magnetic layer. Generally, bit-patterned media might not require as aggressive a heat sink as would be required in the continuous conventional media, since the thermal spread is prevented and similar thermal FWHMs are expected. A less aggressive heat sink layer means higher temperature increases.

The data rates in a HAMR system are determined by how fast the previously heated magnetic volume cools down. To achieve higher data rates, the magnetic volume should be heated and cooled faster. The heat-sink layer determines how fast the magnetic volume cools down. Therefore, selecting a material with high thermal conductivity or increasing the heat sink thickness will permit higher data rates. As previously mentioned, increasing the thermal conductivity or the thickness will result in lower temperatures in the magnetic media. Therefore, this trade off should be adjusted based on the system requirements.

The isolated bit and grain volumes can be formed in a variety of shapes. For example, granular particles of random shapes could be used. Other possible media pattern shapes include rectangular prism, cylinder, sphere, hexahedral, pentahedral, and tetrahedral. However, the invention is not limited to any particular shape of the magnetic recording elements. The shape and performance of the optical transducer, the interaction between the media volumes and optical transducer, the interaction and distance between the media volumes, the composition of the medium and the underlayer, the data rate, the temperature increase, the magnetic stability, and spot size requirements are some of the factors to be considered in determining the shape and size of the bits and grains.

In the various described patterned media examples, the isolated magnetic recording grains can be, for example, CoPtCr, CO₃Pt, FePt or other suitable preferably perpendicular magnetic recording materials. The heat sink can be, for example, Ag, Au, Cu, CuZr or Al. The substrate can be, for example, Al, glass, or plastic. The bulk electrical conductivities of several materials that can be used in the media of this invention include: Ag=6.82×10⁷(Ωm)⁻¹, Au=4.88×10⁷(Ωm)⁻¹, Cu=6.48×10⁷ (Ωm)⁻¹, Al=4.14×10⁷(Ωm)⁻¹, Fe=1.17×10⁷(Ωm)⁻¹, Pt=1.04×10⁷ (Ωm)⁻¹, Co 1.79×10⁷(Ωm)⁻¹. The bulk thermal conductivities include: Ag=4.29 W/(cm K), Au=3.19 W/(cm K), Cu=4.03 W/(cm K), Al=2.36 W/(cm K), Fe=0.865 W/(cm K), Pt=0.717 W/(cm K), Co=1.05 W/(cm K). However, for thin films the parallel and perpendicular conductivities may deviate from these values. This may assist in producing heat sink layers with anisotropic conductivities.

The operating frequency of the laser is another factor determining the efficiency of the final recording medium design. Therefore, the final design must be optimized as a function of frequency including the frequency-dependent material properties.

The medium of this invention uses discrete and separated magnetic recording grains that may be substantially thermally and electrically isolated from each other. It is understood that even with air or another thermally insulating material between the grains, there could be traces of thermal and/or optical conductions. Depending on the inter-grain spacing, there could possibly also be a very small tunneling current. So the grains may not be completely electrically or thermally isolated.

While the described examples show the use of a metal pin as a means for delivering an electric field to the recording medium, it should be understood that any other device for producing electromagnetic radiation having an electric field component substantially perpendicular to the surface of the heat sink can be used in combination with the patterned media of this invention.

The medium 40 is schematically represented in the figures as having a laminated structure, including a substrate 46, a heat sink layer 44, and a hard magnetic layer 42. A separate soft magnetic layer (not shown) may be provided below or above the heat sink layer to provide a return magnetic path for perpendicular recording. In the illustrated embodiment, the aforementioned layers are stacked (e.g., by deposition) in the sequence shown in FIG. 2. However, it is contemplated that to the extent it is consistent with the features, functions and purpose of the present invention disclosed herein, (a) the various layers may be stacked in a different sequence not shown; (b) intermediate layer or layers of materials (e.g., a buffer layer, a primer layer) may be present or provided between adjacent layers, to achieve desired magnetic properties, structural properties, manufacturability, and/or other properties; (c) the reference herein to one layer being above, below, on, or under another layer does not necessarily mean immediately above, below, on, or under, and does not preclude the addition of intermediate layer or layers (i.e., the use of terms such as “adjacent” and the like mean both in contact with or near to another structure); (d) certain layer or layers may be omitted or replaced by other equivalent or different layer or layers of material; (e) one or more of the layer structures may include a multilayered structure and/or sub-layers of same or different materials; (f) one or more of the layer structures shown need not be of a continuous structure (e.g., the bit patterned hard magnetic layer 42, or a self assembled monolayer of hard magnetic material); (g) one or more of the layers need not be of uniform thickness (e.g., a bit patterned hard magnetic layer, or a self assembled monolayer of hard magnetic material); and (h) a single layer may also serve to function with the characteristics of another layers (e.g., the heat sink layer 44 may also function as a soft magnetic underlayer). Other variations may be implemented without departing from the scope and spirit of the present invention.

While the invention has been particularly shown and described with reference to the preferred embodiments, it will be understood by those skilled in the art that various changes in form and detail may be made without departing from the spirit, scope, and teaching of the invention. For example, the magnetic recording head can include additional components to facilitate optical coupling. Furthermore, the present invention may be implemented in other types of data recording transducers (e.g., optical recording transducers, magneto-resistive transducers, etc.) and/or for use with other types of data recording media in other types of data recording systems (e.g., magnetic tape drive systems, magnetic disc drive systems, optical data recording systems, etc.), without departing from the scope and spirit of the present invention. Accordingly, the disclosed invention is to be considered merely as illustrative and limited in scope only as specified in the appended claims.

1. A magnetic recording medium, comprising:
a substrate; and
a magnetic layer supported by the substrate, wherein the magnetic layer comprises an array of discrete and separated magnetic data bits, each comprising an array of discrete and separated magnetic grains.

2. The magnetic recording medium of claim 1, wherein the array of magnetic grains are thermally and optically isolated.

3. The magnetic recording medium of claim 1, wherein the magnetic data bits are uniformly distributed across the magnetic layer, and the magnetic grains are uniformly distributed within each magnetic data bit.

4. The magnetic recording medium of claim 3, wherein the magnetic grains are non-uniformly distributed across the magnetic layer.

5. The magnetic recording medium of claim 1, further comprising a heat sink layer supported by the substrate, said heat sink layer thermally coupled to the magnetic recording layer to dissipate heat from the magnetic recording layer.

6. The magnetic recording medium of claim 1, wherein the heat sink layer comprises a magnetically soft layer magnetically coupled to the magnetic layer.

7. The magnetic recording medium of claim 1, wherein the magnetic grains are distributed in a pattern determined by (a) EPF, which is ratio of total area of magnetic material in one magnetic data bit to total area of the magnetic data bit; and (b) PF, which is ratio of total area of physical coverage of magnetic grains to total area of effective magnetic recording surface.

8. The magnetic recording medium of claim 7, wherein the EPF is an indicator representing the effectiveness of magnetic read-back signal provided by the magnetic recording medium, and the PF is an indicator representing the effectiveness of optical/thermal absorption by the magnetic recording medium.

9. The magnetic recording medium of claim 7, wherein the PF is less than 0.5, and EPF is greater than 0.7.

10. The magnetic recording medium of claim 7, wherein the magnetic grains are distributed within a magnetic bit such that EPF is greater than 0.7 and the magnetic data bits are distributed with a spacing such that PF is less than 0.5.

11. The magnetic recording medium of claim 10, wherein the magnetic grains are distributed within a magnetic bit such that EPF is about 0.7, and the magnetic data bits are distributed with a spacing such that PF is about 0.175.

12. The magnetic recording medium of claim 1, wherein the magnetic grains are distributed with a spacing b within the arrays of magnetic grains, and wherein the arrays of magnetic grains are separated with a spacing W that is greater than b.

13. The magnetic recording medium of claim 12, wherein the magnetic grains are distributed in rectangular arrays.

14. The magnetic recording medium of claim 12, wherein the magnetic grains are distributed in square arrays.

15. The magnetic recording medium of claim 12, wherein the magnetic grains are distributed in arrays of parallel tracks.

16. A perpendicular magnetic recording medium, comprising:
a substrate; and
a magnetic layer supported by the substrate, wherein the magnetic layer is configured for perpendicular magnetic recording, and comprises an array of discrete and separated magnetic data bits, each comprising an array of discrete and separated magnetic grains.

17. A data storage system, comprising:
a magnetic recording medium as in claim 1;
a data recording head directing a magnetic field at the magnetic recording medium; and
an actuator supporting and positioning the data recording head with respect to the data recording medium to effect data recording.

18. The system of claim 17, wherein the magnetic recording medium is configured for perpendicular data recording and the data recording head is supported and positioned by the actuator relative to the data recording medium to effect perpendicular magnetic recording on the magnetic recording medium.

19. A method of magnetic data recording, comprising the steps of:
providing a magnetic recording medium as in claim 1;
providing a data recording head to direct a magnetic field at the magnetic recording medium; and
supporting and positioning the data recording head with respect to the data recording medium to effect data recording.

20. A method of making a magnetic recording medium, the method comprising:
providing a substrate; and
forming a magnetic layer supported by the substrate, wherein the magnetic layer comprises an array of discrete and separated magnetic data bits, each comprising an array of discrete and separated magnetic grains.
